(19) United States
(12) Patent Application Publication
(10) Pub. No.: US 2023/0016747 A1
(43) Pub. Date: Jan. 19, 2023

(54) Cleaning Kit with Reusable Applicator and Compact Structure

(71) Applicant: Podsy Partners, LLC, San Diego, CA (US)

(72) Inventors: Daniel Robert Klunk, San Diego, CA (US); Jason Elsmore, San Diego, CA (US)

(73) Assignee: Podsy Partners, LLC, San Diego, CA (US)

(21) Appl. No.: 17/862,211

(22) Filed: Jul. 11, 2022

Related U.S. Application Data
(60) Provisional application No. 63/222,393, filed on Jul. 15, 2021.

(51) Int. Cl. B65D 77/04; B05B 11/00

(52) U.S. Cl. CPC B65D 77/04; B05B 11/0038; B65D 2577/041

(57) ABSTRACT

A cleaning kit includes a fluid bottle, a container, and a dispense head. The fluid bottle has a major axis Z and includes a reservoir and a top with an opening. The container is disposed within the reservoir and has a plurality of dissolvable pods. The dispense head is mounted to the top of the fluid bottle and includes a suction tube that extends into the reservoir. This provides a very space efficient way to ship and display the cleaning kit and to protect the plurality of dissolvable pods.

### CROSS-REFERENCE TO RELATED APPLICATIONS

This non-provisional patent application claims priority to U.S. Provisional Application Ser. No. 63/222,393, entitled “Cleaning Kit with Reusable Applicator and Compact Structure” by Daniel Robert Klunk, filed on Jul. 15, 2021, incorporated herein by reference under the benefit of U.S.C. 119(e).

### FIELD OF THE INVENTION

The present disclosure concerns cleaning kits that utilize a spray application of a dissolved cleaning agent. More particularly, the present disclosure concerns cleaning kits with reusable applicators that have a compact structure to facilitate efficient shipment, storage, and display.

### BACKGROUND

Cleaning supplies for home and office are widely available. One very convenient form of cleaning supply is a spray applicator prefilled with a cleaning agent. Drawbacks with prefilled spray applicators include environmental impact of disposal and a cost of storage, shipping and display. There is an ongoing need to make improvements to reduce cost and adverse effects of disposal on the environment.

### BRIEF DESCRIPTION OF THE FIGURES

FIG. 1 is an isometric front view of a first embodiment of a cleaning kit including a spray applicator enclosing a container having a plurality of dissolvable pods.

FIG. 2 is an isometric front view of a first embodiment of a container having a plurality of dissolvable pods.

FIG. 3 is a process flow showing the manufacturing and configuration of a cleaning kit.

FIG. 4 is an isometric front view of a second embodiment of a cleaning kit including a spray applicator enclosing a container having a plurality of dissolvable pods.

FIG. 5 is an isometric front view of second embodiment of a container having a plurality of dissolvable pods.

### SUMMARY

In a first aspect of the disclosure, a cleaning kit includes a fluid bottle, a container, and a dispense head. The fluid bottle has a major axis aligned with a Z-axis and includes a reservoir and a top with an opening. The container is disposed within the reservoir and has a plurality of dissolvable pods. The dispense head is mounted to the top of the fluid bottle and includes a suction tube that extends into the reservoir. This provides a very space efficient way to ship, protect, and display the cleaning kit.

In one implementation the suction tube engages the container and limits motion of the container within the reservoir. This helps to prevent or limit contents shifting during shipment and obviates a need for packing material within the reservoir. Packing material can be difficult to remove, adversely impacts an appearance on display, adds cost, and is not preferred from an environmental impact standpoint.

In another implementation, the reservoir includes features to generally align an axis of the container with the major Z-axis and to center the container within the reservoir. This alignment may be such that an angle defined between the axis of the container and the Z-axis is an acute angle, less than 30 degrees, less than 20 degrees, less than 10 degrees, less than 5 degrees, or as close to 0 degrees as possible. This alignment provides maximum protection to the dissolvable pods from all sides. The fluid bottle reservoir can include a bottom or lower feature that centers a lower end of the container so as to minimize the angle between the container axis and the Z-axis and to maximize a distance between the dissolvable pods and an outer surface of the reservoir thus further protecting the dissolvable pods. The bottom or lower feature of the reservoir can be configured or tapered to engage and self-align and self-center the lower end of the container with respect to the reservoir. The bottom or lower feature of the reservoir can include a circular ridge (or other feature that slopes inwardly in a downward direction) with an inner surface to engage and align the lower end of the container upon insertion of the container into the reservoir. In order to further facilitate the engagement, alignment or centering of the lower end of the container with respect to the reservoir, an automated manufacturing or packaging process could be implemented subsequent to placement of the container within the reservoir. An example of such an automated manufacturing or packaging process is to place the fluid bottle with the enclosed container upright on a table or conveyer and subjecting the table or conveyer to a predetermined mechanical vibration or shaking process. Such vibration or shaking process could self-align and self-center the lower end the container with respect to the reservoir.

In yet another implementation, the container has a major axis that is generally along the major axis Z of the fluid bottle. The container contains a plurality of arrangements of dissolvable pods. The arrangements overlap along the major axis of the container. This is a very efficient method of storing dissolvable pods within the form factor of the container.

In a further implementation, the reservoir has bottom end with a lower inner surface. The lower inner surface has a portion that tapers toward a central vertical or major z-axis of the fluid bottle or reservoir. The lower inner surface includes a circular ridge surrounding a bowl. The bowl is the portion of the lower inner surface that tapers toward the central vertical or major z-axis. A circular recess is defined between the circular ridge and a lower wall of the reservoir. At least one radially extending channel divides the circular ridge and fluidically connects a bottom of the bowl and the circular recess. The bowl provides a “self-centering” of a lower end of the container on the lower inner surface of the reservoir upon insertion into the fluid bottle. Engagement of a cylindrical side surface of the container with the suction tube combined with engagement of the lower end with the bowl help to maintain the position and orientation of the container within the reservoir. This helps to avoid damage during shipment to a retailer. The radially extending channel maximizes fluid extraction efficiency by the suction tube.

In a second aspect of the disclosure, a method of manufacturing a cleaning kit includes the following steps: (A) providing (1) a fluid bottle including a reservoir and a top with an opening, (2) a container having a plurality of dissolvable pods, and (3) a dispense head having a suction tube; (B) placing the container into the reservoir of the fluid bottle; (C) assembling the dispense head to the top of the fluid bottle, the suction tube extends into the reservoir after the assembling.

In one implementation assembling the dispense head to the top of the fluid bottle includes engaging the suction tube with the container to constrain motion of the container.

In another implementation, placing the container into the reservoir includes placing a major axis of the container generally along a major axis of the fluid bottle meaning that the major axis of the container defines an acute angle with respect to the major axis of the fluid bottle. Preferably the acute angle is less than or equal to 30 degrees or 20 degrees.

In yet another implementation, the reservoir has a bottom end with a lower inner surface including an inwardly sloping surface configured to at least partially center a lower end of the container within the reservoir when it is placed into the reservoir.

In a third aspect of the disclosure, a method of configuring a cleaning kit for use includes the following steps: (A) receiving the cleaning kit including: (1) a fluid bottle including a reservoir and a top with an opening, (2) a container disposed within the reservoir, the container having a plurality of dissolvable pods, and a dispense head mounted to the top of the fluid bottle and including a suction tube that extends into the reservoir; (B) removing the dispense head from the fluid bottle; (C) removing the container from the fluid bottle; (D) placing one of the plurality of the dissolvable pods into the fluid bottle; (E) at least partially filling the reservoir with water; and (F) assembling the dispense head to the fluid bottle and shaking the contents prior to use.

### DETAILED DESCRIPTION OF THE PREFERRED EMBODIMENTS

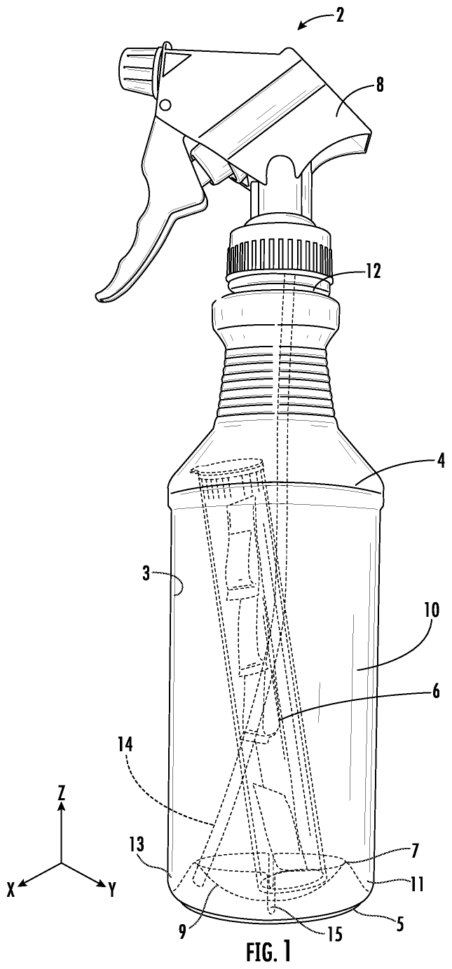

FIG. 1 is an isometric drawing of a first embodiment of a cleaning kit 2 assembled for display or shipment. In describing cleaning kit 2, mutually orthogonal axes X, Y and Z can be used. The X and Y axes are otherwise referred to as lateral axes. The Z-axis is otherwise referred to as a vertical or major axis. When the term “generally” is used it means by design but may vary according to tolerances. The term “generally along” means that objects are aligned within an acute and oblique angle.

Cleaning kit 2 includes a fluid bottle 4, a container 6, and a dispense head 8. The fluid bottle 4 has a major axis Z along the Z-axis and includes a reservoir 10 and a top 12 with an opening. Preferably, the fluid bottle 4 is transparent to allow the container 6 to be visible to the consumer during retail display. The container 6 has a major axis that is generally along the major axis Z of the fluid bottle 4. However, the major axis of the container 6 may define an oblique angle with respect to the major axis Z. The dispense head 8 is coupled to the top 12 and covers the opening of the top 12. The dispense head 8 includes a suction tube 14 that extends down into the reservoir 10. The suction tube 14 is disposed so as to engage the container 6 of kit 2 to constrain movement of container 6 in position during shipment of the kit 2 from a manufacturing site or distribution center to a retailer.

The reservoir 10 has an inner surface 3. At a bottom end 5 of the reservoir 10, the inner surface 3 includes a circular ridge 7 which surrounds a bowl 9. A lower part of the inner surface 3 (lower inner surface) tapers inwardly over the surface of the bowl 9. A circular recess 11 is defined between the ridge 7 and a lower wall 13 of the reservoir 10. The circular ridge 7 is not continuous but interrupted by one or more drain channels 15 which fluidically couple the bowl 9 to the circular recess 11. The distance between the circular ridge 7 and the inner surface 3 of the reservoir 10 is preferably less than the diameter of the container 6.

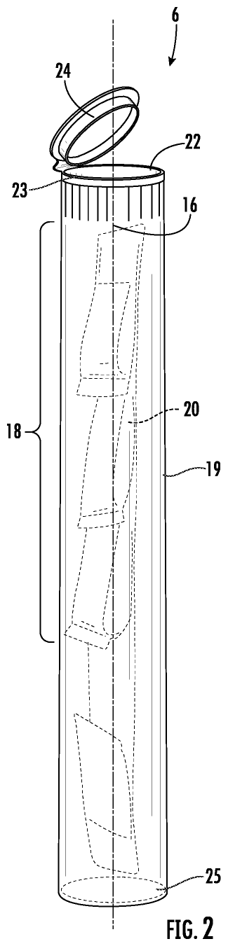

FIG. 2 is an isometric drawing of a first embodiment of container 6 which has a major axis 16. Within the container 6 is a generally linear arrangement 18 of a plurality of dissolvable (refill) pods 20. Note that the arrangement 18 in the preferred embodiment comprises four or more dissolvable (refill) pods 20, although Fig.'s 2, 5 illustrate an abbreviated grouping of three pods 20 for illustrative purposes. The arrangement 18 has a major axis that is generally along the major axis 16 of the container 6. Also a plurality of dissolvable pods 20 are disposed within the container 6 and they mostly overlap with respect to the major axis 16. The container 6 also includes an opening 22 at an upper end 23 for receiving the arrangement 18 and a closure 24 for sealing the opening 22. Preferably, both the closure 24 and the container 6 is designed to be child-resistant and tamper-resistant when in the closed position and when packaged and shipped from manufacturer. The container 6 has a cylindrical side surface 19 and a lower end 25 at an opposing end from the opening 22.

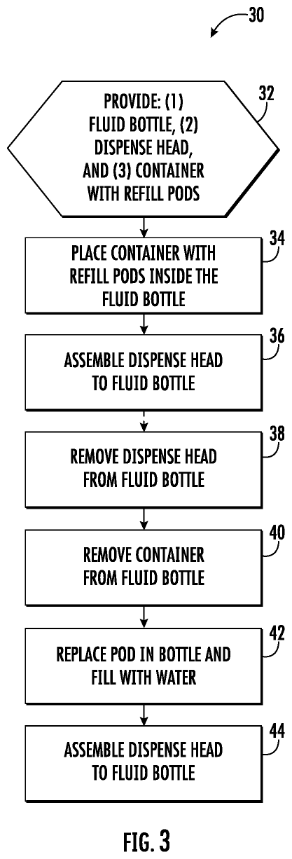

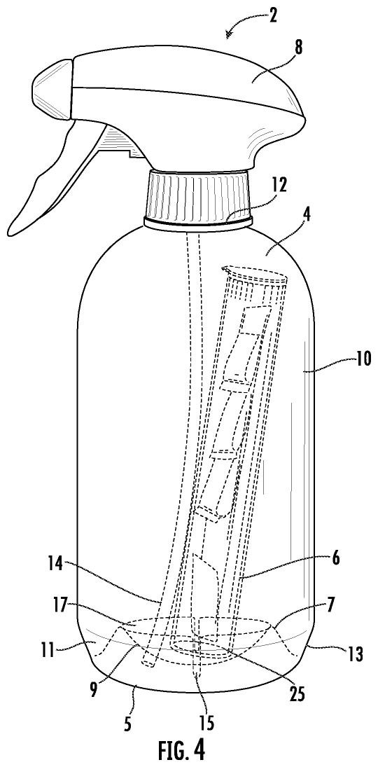

FIG. 3 is a flowchart of an embodiment of a process 30 for manufacturing and preparing the kit 2. Steps 32-36 concern manufacture and steps 38-44 concern preparation. According to 32, an initial provision is made of the fluid bottle 4, the container 6 containing the dissolvable pods 20, and the dispense head 8. According to 34, the container 6 is placed inside the fluid bottle 4. The container 6 can be loaded and positioned with the lower end 25 of the container 6 at the bottom end 5 of the reservoir 10 (as is illustrated in the FIGS. 1, 4), or alternatively, with the upper end 23 at the bottom end 5 of the reservoir 10 as desired for easy removal of the container 6 from the opening of the top 12 or as desired to increase flexibility and functionality. In instances where the upper end 23 is positioned at the bottom end 5 of the reservoir 10, the upper end 23 will be defined herein as the lower end 25 throughout for purposes of describing the alignment of the container with the reservoir. According to 36, the dispense head 8 is assembled to the fluid bottle 4. In an embodiment, the suction tube 14 of the dispense head 8 engages the container 6 to constrain motion of the container 6 within the reservoir 10.

Between steps 36 and 38, the kit 2 is transferred from a manufacturing facility to an end user of the kit 2. This can include packaging, shipping, and displaying within a retail setting. During shipping, the major axis 16 of container 6 defines an acute angle or a nearly 0 degree angle with respect to the major axis Z of the fluid bottle 4. This angle is in part maintained by an engagement of suction tube 14 with the container 6 and/or other features designed into the reservoir 10 that serve to help stabilize and center the container 6 within the reservoir 10. This allows the container 6 to be nearly centered and aligned within the reservoir 10, thus maximizing a distance between the dissolvable pods 20 and an outer surface of the fluid bottle 4. This geometry and stabilization protects the dissolvable pods 20. In the illustrated embodiment, the reservoir 10 has a diameter that is a multiple or more than 3 times the diameter of the container 6 to provide a distance between an outer surface of reservoir 10 and the container 6.

In the illustrated embodiment of FIG. 1 the particular geometry of the circular ridge 7 and bowl 9 provide benefits for process 30. During step 34, a tapering surface of bowl 9 engages and centers the lower end 25 of the container 6 within the reservoir 10, or alternatively, engages and centers the upper end 23 of the container 6 if it is positioned at the bottom end 5 of the reservoir 10 as described in the alternative embodiment. During step 36, the suction tube 14 helps to maintain a nearly vertical orientation of the container 6 which protects the container 6 during shipping between steps 36 and 38.

According to 38, the dispense head 8 is removed from the fluid bottle 4. According to 40, the container 6 is removed from the fluid bottle 4. According to 42, one of the plurality of dissolvable pods 20 from container 6 is placed in the fluid bottle 4. Also according to 42, water is added to the fluid bottle 4. According to 44, the dispense head 8 is assembled to the fluid bottle 4. As part of step 44, the fluid bottle 4 is shaken to dissolve the dissolvable pods in the water within the reservoir 10.

The drain channels 15 in the circular ridge then add a benefit. As part of step 44, the suction tube extends into the bowl 9 or into the circular recess 11. The drain channels 15 assure a maximum extraction of fluid from the bottom end 5 of the reservoir 10.

FIG. 4 is an isometric drawing of a second embodiment of a cleaning kit 2 in a shipping and display configuration. Relative to FIG. 1, like numerals indicate similar elements and functions. As described supra, the bowl 9 engaging the lower end 25 of container 6 has a “self-centering” effect of centering the lower end 25 of container within reservoir 10. Engagement of the suction tube 14 with the container 6 helps to maintain an orientation of the container 6 within reservoir 10 to minimize damage during shipment. Also as described supra, the drain channels 15 that radially interrupt the circular ridge 7 minimize “stranded fluid” that would otherwise be difficult to extract by the suction tube 14. Thus, the drain channels 15 maximize the fluid capacity of the fluid bottle 4 during use.

For both FIGS. 1 and 4, the bottom end 5 of the reservoir 10 includes a lower inner surface 17. A portion of the lower inner surface 17 is an inwardly sloping surface that tapers inwardly and radially so as to receive and center the lower end 25 of the container 6 within reservoir 10. The lower inner surface 17 includes the circular ridge 7 and the bowl 9. The bowl 9 includes the portion of the lower inner surface 17 that tapers inwardly. The container 6 is therefore engaged at the lower end 25 by the bowl 9 and along the cylindrical side surface 19 by the suction tube 14 to at least partially maintain a placement and orientation of the container 6 within the reservoir 10.

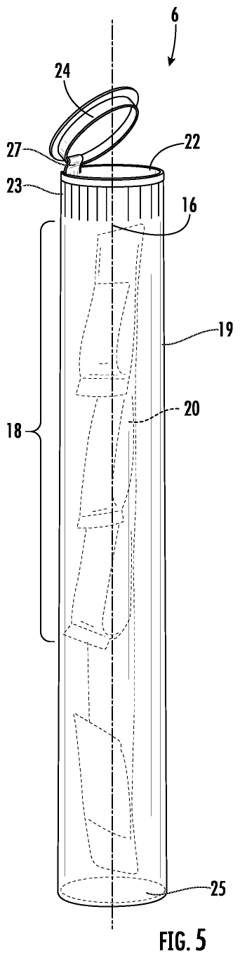

FIG. 5 is an isometric drawing of a second embodiment of a container 6.

Relative to FIG. 2, like numerals indicate similar elements and functions. The closure 24 is coupled to the upper end 23 with an inward folding hinge 27. The inward folding hinge 27 enables use of a larger diameter container 6 and facilitates removal of the container 6 from the fluid bottle 4 without having the hinge 27 hang up on the top of the fluid bottle 4.

The specific embodiments and applications thereof described above are for illustrative purposes only and do not preclude modifications and variations encompassed by the scope of the following claims.

What is claimed:

1. A cleaning kit comprising:
a fluid bottle including a reservoir and a top with an opening;
a container disposed within the reservoir, the container having a plurality of dissolvable pods; and
a dispense head mounted to the top of the fluid bottle and including a suction tube that extends into the reservoir.

2. The cleaning kit of claim 1 wherein the suction tube engages the container and limits motion of the container within the reservoir.

3. The cleaning kit of claim 1 wherein the fluid bottle has a major axis, the container has a major axis that is generally disposed along the major axis of the reservoir.

4. The cleaning kit of claim 1 wherein the reservoir has a bottom end with a lower inner surface that tapers toward a central axis of the reservoir.

5. The cleaning kit of claim 4 wherein the lower inner surface defines a bowl configured to receive and facilitate centering of a lower end of the container.

6. The cleaning kit of claim 5 wherein engagement of the bowl with the lower end of the container and engagement of the suction tube with a side of the container secure a location and orientation of the container within the reservoir.

7. The cleaning kit of claim 4 wherein the lower inner surface defines a circular ridge surrounding a bowl, a circular recess is defined between the circular ridge and a lower wall of the reservoir.

8. The cleaning kit of claim 7 wherein at least one radially extending channel divides the circular ridge and fluidically connects the bowl to the circular recess.

9. A method of manufacturing a cleaning kit comprising: providing:
a fluid bottle including a reservoir and a top with an opening;
a container having a plurality of dissolvable pods; and
a dispense head having a suction tube;
placing the container into the reservoir of the fluid bottle; and
assembling the dispense head to the top of the fluid bottle, the suction tube extends into the reservoir after the assembling.

10. The method of claim 9 wherein assembling the dispense head to the top of the fluid bottle includes engaging the suction tube with the container to constrain motion of the container.

11. The method of claim 9 wherein placing the container into the reservoir includes placing a major axis of the container generally along a major axis of the fluid bottle.

12. The method of claim 9 wherein the reservoir has a bottom end with a lower inner surface including an inwardly sloping surface configured to at least partially center a lower end of the container within the reservoir when it is placed into the reservoir.

13. The method of claim 12 wherein after assembling the dispense head to the top of the fluid bottle the bottom end of the container is engaged by the sloping surface and a side of the container is engaged by the suction tube to at least partially maintain a placement and orientation of the container within the reservoir.

14. The method of claim 12 wherein the lower inner surface defines a circular ridge surrounding a bowl, the bowl defines the inwardly sloping surface.

15. The method of claim 14 wherein a circular recess is defined between the circular ridge and a lower wall of the reservoir.

16. The method of claim 15 wherein at least one radially extending channel divides the circular ridge and fluidically connects the bowl to the circular recess.

17. A method of configuring a cleaning kit for use comprising:
receiving the cleaning kit including:
a fluid bottle including a reservoir and a top with an opening;
a container disposed within the reservoir, the container having a plurality of dissolvable pods; and
a dispense head mounted to the top of the fluid bottle and including a suction tube that extends into the reservoir;
removing the dispense head from the fluid bottle;
removing the container from the fluid bottle;
placing a pod of the plurality of the dissolvable pods into the fluid bottle;
at least partially filling the reservoir with water; and
assembling the dispense head to the fluid bottle.

18. The method of claim 17 further comprising shaking the fluid bottle to dissolve the pod in the water.

19. The method of claim 17 wherein the reservoir has a bottom end with a lower inner surface defining a circular ridge surrounding a bowl.

20. The method of claim 19 wherein a circular recess is defined between the circular ridge and a lower wall of the reservoir, at least one radially extending channel divides the circular ridge and fluidically connects the bowl to the circular recess.
